(19) United States
(12) Patent Application Publication
(10) Pub. No.: US 2022/0047118 A1
(43) Pub. Date: Feb. 17, 2022

(54) HOTBOX FOOD DELIVERY BAG

(71) Applicant: ROMEO JOVEN, JR., MAKATI (PH)

(72) Inventor: ROMEO JOVEN, JR., MAKATI (PH)

(21) Appl. No.: 16/989,932

(22) Filed: Aug. 11, 2020

(51) Int. Cl. A47J 39/02; B65D 81/18; A47J 47/14

(52) U.S. Cl. CPC A47J 39/02; A47J 47/14; B65D 81/18

(57) ABSTRACT

Disclosed is a hotbox food delivery bag that retains temperature for a long time and is easy to operate. The bag comprises a heating kit having a heating pad arranged at inner lower portion. A heating pad cover is configured above the heating pad. A pulling means is attached with heating pad and is extended outside, via a hole, from bag body. A pull ring is attached at exterior end of pulling means to pull the pulling means to activate the heating pad. A tray is placed above heating pad cover, wherein the packed food shall be placed above the tray to heat the food. A method of operating the bag comprises placing food package on a tray which is placed inside the bag and pulling a pulling means of heating kit, using a pull ring, through a hole, whereby heating the food by the steam that generates from heating kit.

### TECHNICAL FIELD

The present invention relates to a food delivery system and more particularly relates to a hotbox food delivery bag which is self-heating by an action of pulling a pulling means.

### BACKGROUND

The practice of online ordering of foods has been increasing day by day due to various reasons by the people including office goers, restaurant foods lovers, bachelors or spinsters, and during various instances such as partying at home or office, and the like. During such instances, it is required to keep the food hot and so that the food shall taste good and enjoyable. Conventionally, the restaurants deliver foods in paper bags, foils, plastic bags or cartons, so that the warmness of food tends to be reduced and then the food becomes chilled.

Several patents have been disclosed with methods of heating the food in a food delivery bag. Such methods make use of magnetic induction heating, so that the food delivery bags become heavy even for delivering small food parcels, due to the size of the induction heating kit of food delivery bags. Also, the induction heating methods consume more time to activate the heating system and are complicated to operate.

More specifically, utilizing the conventional heating methods of food in the food delivery bags moist the paper packaging of food inside the delivery bag, due to the steam generated from the food heating kit. Conventional heating method shall not retain the temperature for a long time.

### SUMMARY

It is an object of the present invention to provide a hotbox food delivery bag that is easy to operate.

It is an object of the present invention to provide a hotbox food delivery bag that shall not moist the food packaging inside the delivery bag.

It is an object of the present invention to provide a hotbox food delivery bag that shall release the steam out of the delivery bag.

It is an object of the present invention to provide a hotbox food delivery bag that shall retain the temperature for a long time.

According to an exemplary embodiment of present invention, a hotbox food delivery bag comprises a bag body, a heating kit arranged inside the bag body, wherein the heating kit comprises, a heating pad arranged at the inner lower portion of the food delivery bag, a heating pad cover configured above the heating pad in order to cover the heating pad, a pulling means attached with the heating pad of the food delivery bag, wherein the pulling means is extended outside, via a hole, from the inner portion of the bag body, a pull ring attached at the exterior end of the pulling means, wherein the pull ring is configured to pull the pulling means in order to activate the heating pad, and a tray placed above the heating pad cover, wherein the packed food shall be placed above the tray in order to heat the food.

According to another embodiment of present invention, a method of operating a hotbox food delivery bag, comprising placing the food package on a tray which is placed inside the food delivery bag and pulling a pulling means of the heating kit, using a pull ring, through a hole formed at the front portion of the food delivery bag, whereby heating the food by the steam that generates from a heating pad of the heating kit.

The foregoing section has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims.

### BRIEF DESCRIPTION OF DRAWINGS

The present invention will become clearly understood to those of ordinary skill in the art when descriptions of exemplary embodiments thereof are read with reference to the accompanying drawings.

FIG. 1 is a perspective view of a hotbox food delivery bag in opened position.

FIG. 2 is a perspective view of the hotbox food delivery bag in closed position.

FIG. 3 is a perspective view of the heating kit.

### DETAILED DESCRIPTION

The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention. For a more complete understanding of the present invention, reference is now made to the following descriptions taken in conjunction with the accompanying drawings.

The present invention discloses a hotbox food delivery bag which is self-heating by the action of pulling a pulling means. The hotbox food delivery bag is also referred to as “hotbox food box,” “hotbox benta box,” or “hotbox platter box.” The customers expect the food to be hot while having it delivered. Hence, the hotbox delivery bag of present invention is designed as a self-heating food delivery bag that heats up while delivering the meals.

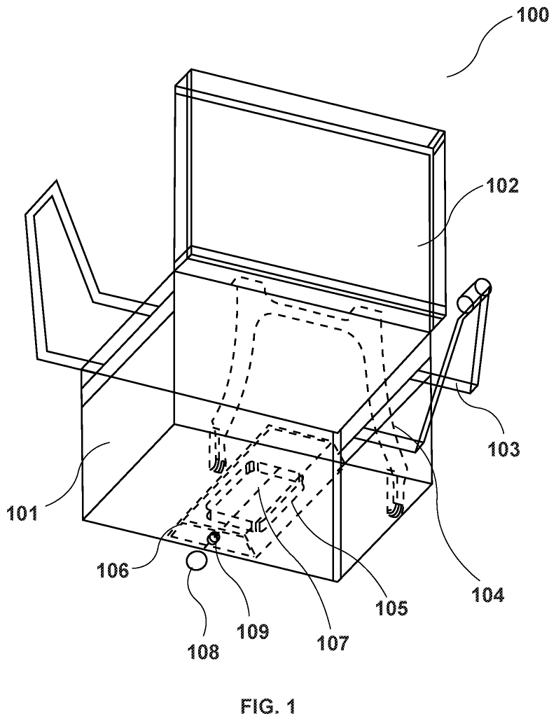

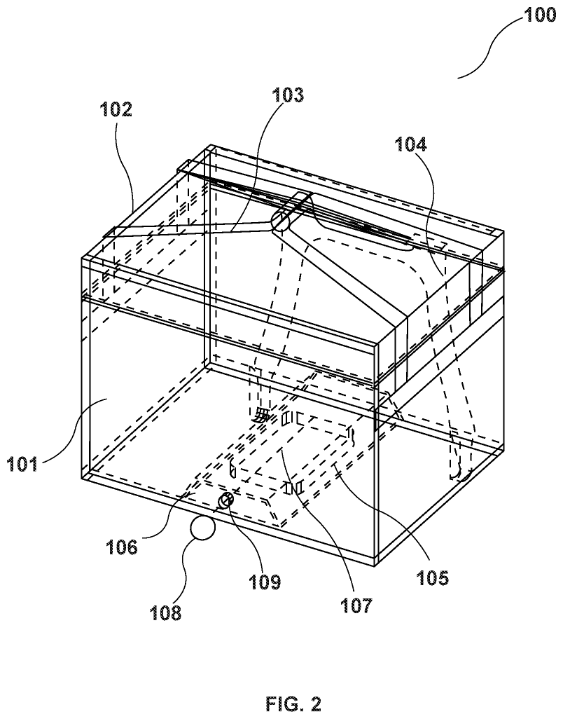

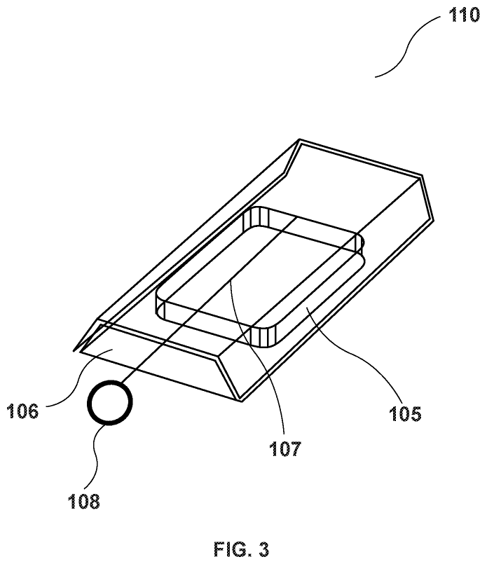

The hotbox food delivery bag 100 is illustrated in FIGS. 1 and 2 in opened and closed position, respectively. FIG. 3 shows a heating kit 110 of the present invention. The food delivery bag 100 of the present invention comprises a bag body 101, a tray (not shown) and a heating kit 110, wherein the tray and the heating kit 110 are configured inside the bag body 101. The heating kit 110 comprises a heating pad 105 which is placed at the inner lower portion of the food delivery bag 100. A heating pad cover 106 is configured above the heating pad 105 in order to cover the heating pad 105. The food delivery bag 100 is a made of nylon or vinyl.

The heating kit 110 also includes a pulling means 107 which is attached with the heating pad 105 of the food delivery bag 100, wherein the pulling means 107 is extended outside, via a hole 109, from the inner portion of the bag body 101. According to the present invention, the pulling means 107 shall be a pull string, pull cord, pull chain, straw and the like.

The hole 109 is formed at the front portion of the food delivery bag 100. A pull ring 108 is attached at the exterior end of the pulling means 107, wherein the pull ring 108 is configured to pull the pulling means 107 in order to activate the heating pad 105. The food delivery bag 100 also includes a tray (not shown) which is placed above the heating pad cover 106 for placing and heating the packaged food. Wherein the food delivery bag 100 is a made of nylon or vinyl.

The bag body 101 is attached with a bag cover 102 which acts as the closure of the food delivery bag 100, and one or more side straps 103 are provided at the side portions of the bag 100. The side straps 103 include a hook-and-loop closure or side release buckle closure. Additionally, the bag body 101 is attached with a knapsack 104 at the back portion of the bag 100. The tray separates the packaged food and the heating kit 110. When the packaged food is placed on the tray, the pulling means 107 is pulled using the pull ring 108, via the hole 109, external to the food delivery bag 100, thus the food is heated by the steam that is being generated from the heating pad 105, while the food is en route to the customer. With the arrangement of the hole 109, the remaining steam shall also be released outside the bag 100, thus avoiding the food package become moisture.

The present invention also includes a method of operating a hotbox food delivery bag 100 which is shown in FIGS. 1 and 2. The method involves placing the food package on a tray which is placed inside the food delivery bag 100. A pulling means 107 of the heating kit 110 is pulled, using a pull ring 108, through a hole 109 formed at the front portion of the food delivery bag 100, whereby the food is heated by the steam that generates from a heating pad 105 of the heating kit 110. According to the present invention, the pulling means 107 shall be a pull string, pull cord, pull chain, straw and the like. The packaged food which is heated by the present method shall retain the heat for at least 30 minutes.

According to the present invention, the pulling means 107 is attached with the heating pad 105 of the heating kit 110, wherein the heating pad 105 is covered with a heating pad cover 106. The tray which is being used for placing the food is placed above the heating pad cover 106. The tray separates the heating kit 110 and the food.

The packed food is heated, while delivering to the customers, by pulling the pulling means 107 on the heating kit 110. With the arrangement of the hole 109, the remaining steam shall also be released outside the bag 100, thus avoiding the food package become moisture.

It will finally be understood that the disclosed embodiments are presently preferred examples of how to make and use the claimed invention and are intended to be explanatory rather than limiting of the scope of the invention as defined by the claims below. Reasonable variations and modifications of the illustrated examples in the foregoing written specification and drawings are possible without departing from the scope of the invention as defined in the claim below. It should further be understood that to the extent the term “invention” is used in the written specification, it is not to be construed as a limited term as to number of claimed or disclosed inventions or the scope of any such invention, but as a term which has long been conveniently and widely used to describe new and useful improvements in technology. The scope of the invention supported by the above disclosure should accordingly be construed within the scope of what it teaches and suggests to those skilled in the art, and within the scope of any claims that the above disclosure supports. The scope of the invention is accordingly defined by the following claims.

This application is intended to cover any adaptations or variations of the present invention. Therefore, it is manifestly intended that this invention be limited only by the claims and the equivalents thereof.

1. A hotbox food delivery bag, comprising:
a bag body;
a heating kit arranged inside the bag body, wherein the heating kit comprises:
a heating pad arranged at the inner lower portion of the food delivery bag;
a heating pad cover configured above the heating pad in order to cover the heating pad;
a pulling means attached with the heating pad of the food delivery bag, wherein the pulling means is extended outside, via a hole, from the inner portion of the bag body;
a pull ring attached at the exterior end of the pulling means, wherein the pull ring is configured to pull the pulling means in order to activate the heating pad; and
a tray placed above the heating pad cover, wherein the packed food shall be placed above the tray in order to heat the food.

2. The food delivery bag of claim 1, wherein the food delivery bag is a made of nylon or vinyl.

3. The food delivery bag of claim 1, wherein the hole is formed at the front portion of the food delivery bag.

4. The food delivery bag of claim 1, wherein the pulling means is a pull string, pull cord, pull chain, straw and the like.

5. The food delivery bag of claim 1, wherein the bag body is attached with a bag cover as a closure of the bag.

6. The food delivery bag of claim 1, wherein the bag body is attached with one or more side straps at the side portions of the bag.

7. The food delivery bag of claims 1 and 6, wherein the side straps include a hook-and-loop closure or side release buckle closure.

8. The food delivery bag of claim 1, wherein the bag body is attached with a knapsack at the back portion of the bag.

9. A method of operating a hotbox food delivery bag, comprising:
placing the food package on a tray which is placed inside the food delivery bag; and
pulling a pulling means of the heating kit, using a pull ring, through a hole formed at the front portion of the food delivery bag, whereby heating the food by the steam that generates from a heating pad of the heating kit.

10. The method of claim 9, wherein the heating pad of the heating kit is covered with a heating pad cover.

11. The method of claim 9, wherein the pulling means is a pull string, pull cord, pull chain, straw and the like.

12. The method of claim 9, wherein the tray is placed above the heating pad cover of the heating kit.

13. The method of claim 9, wherein the pulling means is attached with the heating pad of the heating kit.

14. The method of claim 9, wherein the packaged food heated by the heating pad shall retain the heat at least 30 minutes.
